(19) United States
(12) Patent Application Publication
(10) Pub. No.: US 2012/0123981 A1
(43) Pub. Date: May 17, 2012

(54) SOFTWARE TO FACILITATE DESIGN, DATA FLOW MANAGEMENT, DATA ANALYSIS AND DECISION SUPPORT IN STRUCTURAL HEALTH MONITORING SYSTEMS

(76) Inventors: Spencer B. Graves, San Jose, CA (US); Sam Kovnat, North Stonington, CT (US); James C. Elliott, Parker, CO (US)

(21) Appl. No.: 13/343,440

(22) Filed: Jan. 4, 2012

Related U.S. Application Data
(63) Continuation-in-part of application No. PCT/US2010/002162, filed on Aug. 4, 2010.
(60) Provisional application No. 61/431,193, filed on Jan. 10, 2011.

(51) Int. Cl. G06N 3/12; G06F 17/30

(52) U.S. Cl. 706/13; 707/693; 707/E17.005

(57) ABSTRACT

This patent application describes (a) software to help people design monitoring systems and (b) methods to facilitate enhanced data flow management (including from large numbers of simultaneous sources), diagnostic and statistical analyses based on novel concepts of data compression using statistical state space techniques. The design assistance is structured around known but not widely practiced procedures such as documented in Graves, Rens and Rutz (2011). For data flow management, the present invention may transmit and store an estimated state space model only when the last stored model is not adequate to predict recent observations. It may also transmit and store outliers and samples of regular observations. This unique data storage format requires new methods for data analysis to properly extract the information contained therein.

### CROSS-REFERENCE TO RELATED APPLICATIONS

This application claims priority to U.S. Provisional Application No. 61/431,193, filed Jan. 10, 2011, and International Application No. PCT/US2010/002162 filed Aug. 4, 2010. These are incorporated herein by reference in their entireties.

### FEDERALLY SPONSORED RESEARCH

Not applicable.

### NAMES OF PARTIES TO A JOINT RESEARCH AGREEMENT

(none)

### SEQUENCE LISTING OR PROGRAM

(none)

### BACKGROUND

1. Field

This patent application relates to software designed to help people design and use monitoring systems to get the maximum possible information for minimum cost in hardware, software, human time, and data communications and storage. Applications include virtually any repeated data collection situation. This occurs today with monitoring both natural and man-made phenomena. Applications include weather, wildlife behavior research and monitoring geological phenomena such as earthquakes and volcanoes. Similar problems are encountered in monitoring manufacturing, in both discrete parts and continuous flow. Data are collected and used to control and diagnose problems with production and distribution of power, both in power plants and in distribution networks for electricity and transporting oil, natural gas, and coal. Data are used in controlling and diagnosing problems with motor vehicles such as automobiles, trucks, trains, aircraft and ships. Data are routinely collected and used to evaluate the health of structures such as bridges, tunnels, hazmat facilities, buildings, towers, scaffolding, cliffs, caves, mines, and oil and gas drilling and production operations, whether land or sea based as well as ecological and human social, political, economic and financial systems.

The essence of this invention lies in software to make it easy for people to design monitoring systems following a reasonable process such as the 9-steps described by Graves, Rens and Rutz (2011), including state space compression techniques documented in the Graves, Kovnat and Elliott (2011) provisional patent application.

This discussion of background first reviews prior art relating to monitoring in general before focusing on data compression. It ends with a description of the advantages of the invention over prior art.

2. Monitoring

There is a vast literature on monitoring. Advances appear regularly in leading academic journals such as the Journal of Quality Technology, to name only one.

However, most of this literature provides advances in an important but narrow abstraction to the problem of selecting (a) statistics to monitor and (b) limits to balance the delay to detection with either the probability of false alarms (Wikipedia, “Statistical hypothesis testing”) or (more recently) the false discovery rate (Benjamini and Hochberg 1995). This balance may be achieved in a variety of ways, e.g., by minimizing the false discovery rate with a given limit on expected delay to detection or by placing costs or disutilities on each unit of delay and each false discovery and then minimizing the expected cost or disutility.

One of the major obstacles to the growth of automatic monitoring and control systems is the limited availability to responsible decision makers of information on how to easily install and manage such systems to help them make better decisions. Civil engineers and their managers don't want to look at “all those squiggly lines” representing the behavior over time of infrastructure they manage, because they don't know how to translate that information into improved understanding of the condition of the inventory they manage and the consequences of delaying action.

Wenzel (2009, p. 423) outlined four levels of damage identification: (1) Detection, (2) Localization or isolation, (3) Quantification, and (4) Prognosis. There is an opportunity to help people learn basic concepts and principles of monitoring and control and translate those principles into appropriate action through software that provides an adaptable graphical user interface that makes it easy for naive users to think through the complexities of a problem they face and translate their thoughts into useful action. Adaptability means that the system would also be easy to use for an expert trying to get some modification not provided by simplistic solutions acceptable for many problems. Action includes the selection of hardware and data communications, storage and processing protocols with various kinds of adaptable decision limits connected to different responses. Limits may be designed to identify outliers, inadequate predictions, or inappropriate values for estimated parameter(s). Violation of the limits should generate responses such as the following:
Exception for observations that should be emphasized whenever a human wants to look at the data,
Warning to produce an email to a human,
Alarm to generate a phone call to a human, or
Automatic that would shut something down, e.g., close a bridge or initiate a controlled shut down of a manufacturing facility.
   (Graves, 2011, sec. 6) Some commercial software includes the capability to set multiple limits, but we've seen nothing that provides substantive guidance on interpretation (such as the above descriptions of Exception, Warning, Alarm, and Automatic) nor on how to set and use multiple limits with different interpretations (beyond the traditional distinction between specification limits applied to individual units and standard statistical process control limits; Wikipedia (“Statistical Process Control”); Shewhart 1931).

There are opportunities to improve the practice of monitoring by helping people translate available information into appropriate limits and actions triggered by violations of said limits. Users also need help in understanding that initial theoretical computations of limits should in many cases be subsequently evaluated and revised by reference to actual experience; this seems not as far as we know adequately discussed in the prior art. This last step of revision of limits is critically important, because if people see too many alarms, they learn to ignore them, and the monitoring system can become worse than useless, because it engenders disrespect for the entire system. To combat this problem, the final two steps in the Graves, et al. (2011) “9-Step Process for developing a Structural Health Monitoring System” involve evaluating the monitors in actual use and improving people's use of the 9-step process.

Many advanced monitoring systems today can collect data in such high quantities that they vastly exceed the capacities of data communications and storage equipment available at a reasonable price. Of course the storage required can be expressed in terms of the number of bytes, while the communications capacity can be measured in bytes per unit time. While these are separate concepts, in most applications increasing the sampling rate has implications for both communications and storage unless something is done to collocate some substantive portion of the computations with the metrology using, e.g., so-called smart sensors. This opens opportunities for improving monitor design through intelligent choices about which computations provide high quality information at a reasonable cost to support high rates of sampling but much smaller numbers of bits or bytes transmitted and stored. This latter step can involve data compression. We now consider that literature.

### Data Compression

Solomon and Motta (2010) provide a recent survey of the literature on data compression in their 1400 page Handbook of Data Compression, 5th ed. Data compression methods can be divided into lossless and lossy methods depending on whether the original data can be completely restored. Lossless methods are appropriate when any errors in reproduction can create problems. Lossy methods are preferred for data that can be decomposed into informative and noninformative components, where the noninformative component includes measurement error plus potentially finer resolution than is needed for the application of interest. With physical measurements, all realistic methods are ultimately lossy, because the measurements could always be recorded to greater superficial numerical precision. For example, the LabJack U6 programmable data acquisition device allows the user to specify a “resolution index”, giving greater numerical precision while requiring more time to convert each measurement (LabJack, 2010). Nearly all existing data compression algorithms accept the current digital format as given. The present invention provides foundational theory and methods for adjusting the resolution of analog to digital conversion where the needs of the application and the available hardware support that.

A key part of the present application is a lossy compression method that is very different from any other data compression method we've seen. Data collected on the performance of many physical systems start as analog signals that are then converted to discrete numbers at specific points in time. In many cases, the analog to digital conversion process provides more digits than the available instruments can reliably measure. Sufficiently low order bits follow a discrete uniform distribution and provide zero information about the process being measured. Standard lossless data compression algorithms (Wikipedia “data compression”) will in many cases fail to achieve much compression with analog data, and many actually expand rather than compress the data, because the patterns in the data do not match any of the patterns that the algorithm is designed to compress.

These kinds of data require lossy compression, but few lossy compression algorithms exploit the inherently statistical nature of data of these kinds. Moreover, they rarely consider what is known about the underlying physical behavior of the plant (or physical system) being monitored. The methods taught here provide an added incentive to improve the knowledge of the behavior recorded in the data, and those increases in knowledge could provide substantial economic benefits that were not previously considered worth the cost of the research.

Many lossy algorithms that have been developed so far focus on compressing video or audio so humans cannot detect the loss (e.g., Wikipedia “lossy compression”). Recent work has described data compression using piecewise constant approximation (Lazaridis and Mehrotra 2003), Kolmogorov-Sanai entropy (Titchener 2008), a Markov expert system (Cheng and Mitsenmacher 2005), statistical moments (Choi and Sweetman 2009), nonparametric procedures (e.g., Ryabko 2009, 2008), autoregressive moving average summaries (Sridhar et al. 2009), Fourier analysis (e.g., Reddy et al. 2009), extrema (e.g., Fink and Gandhi 2007), neural networks (e.g., Izumi and liguni 2006), and time series data mining (Li2010).

Fleizach (2006) reported good results with “Scientific Data Compression Through Wavelet Transformation”. However, we don't see any general rule in this for deciding how much compression is enough vs. too much.

Shafaat and Baden (2007) discussed “Adaptive Coarsening for Compressing Scientific Datasets”. Their algorithm involves deleting observations from a data set, computing a summary representation from the subset, then inverting the summary operation to interpolate values for the original data. When the differences between the interpolated values and the original data are too great, they stop. These are good ideas, but they provide little guidance for deciding how much error is acceptable.

In principle, piecewise constant approximations could be used in this way for data from accelerometers, for example. However, Lazaridis and Mehrotra (2003), who discussed piecewise constant approximations, used L_{∞} error bounds; the use of L_{∞} is equivalent to assuming uniformly distributed noise, which is produced by few physical processes we know. This suggests that more efficient data compression and subsequent information extraction could be achieved by improved modeling of both the underlying physical process, modeled by Lazaridis and Mehrota as piecewise continuous, and the noise, modeled implicitly by a uniform distribution.

Changes in temperature and displacement can often be modeled with second order differential equations plus measurement noise that may be a mixture of normal distributions but not a uniform. Such second order dynamics could easily be modeled as a hidden Markov process with a two- or three-dimensional state vector consisting of the position, velocity and possibly acceleration. A “Markov expert system” may include such a model as an option but will in general waste resources, including communications bandwidth and data storage capacity, considering alternatives that may be physically impossible for the particular application. Information theory has shown itself to be extremely useful for data compression and communications, but we have so far seen no literature that appropriately considers the known physics of the structure and sensors in so-called “information” or entropy-based data compression and communications. Neural networks and “expert systems” may outperform a Kalman filter that poorly matches the physics. However, we would not expect artificial intelligence to perform as well as real intelligence embedded in an algorithm that appropriately considers the physics of an application.

Systems for distributed Kalman filtering (e.g., Olfati-Saber 2007) can support models closer to the physics than the data compression algorithms we've seen. However, such systems can be extremely difficult to design and use, because we must either specify the model entirely when we install the sensors or allow the system to be reprogrammed remotely. If the model is completely specified in advance, it may be not be feasible to modify the mathematics later to exploit improvements in our understanding of the behavior of the structure. If the system can be reprogrammed remotely, it increases the cost of the smart sensors and computers located with the structure and increases the risks of hacker attacks.

For civil structures, the need for data compression in monitoring and control is widely recognized. Wang and Law (2007) describe, “Wireless sensing and decentralized control of civil structures”. They describe a wireless sensor network where Fourier transforms or autocorrelation functions are computed at sensor nodes to reduce the bandwidth requirements for transmitting data within a wireless local area network on the structure of interest. However, with data transmitted at regular intervals, there are still substantial opportunities for further savings in data communications and storage by (a) transmitting data only when important changes are seen in the Fourier or autocorrelation summaries and (b) limiting the number of bits or digits transmitted and stored through appropriate consideration of the 3-part decomposition (1) described in the next section with the advantages of the proposed system.

Huang et al. (2011) provide an overview of “compressive sensing”. This approach assumes that the behavior of the system monitored can be represented in relatively few dimensions. Finding those relatively few dimensions is essentially a problem of principle components or factor analysis, for which a huge variety of solutions have been developed over the years, with different methods optimal for different purposes.

### Advantages

New computer and sensor technologies provide vast opportunities to improve the productivity of human activities through better monitoring and control of all kinds of processes. The major factor limiting the increased use of these technologies is the limited understanding that potential beneficiaries of such monitoring have of the details of design and use of such monitoring systems. Our software is designed to make it easier for hobbyists, engineering students, practicing engineers and others to learn the principles of monitoring and apply them in applications of interest to them. As more people become better able to understand and use monitoring technologies, the rate of growth in use of those technologies will increase. This in turn can be expected to contribute to better decisions regarding how to get more value from existing investments at a lower total cost.

A portion of this software deals with the cost of data communications and storage. This is a major issue, especially with modern smart and wireless sensors deployed in remote locations where the electrical power budget is a major portion of the cost. Existing computer and sensor technology can support collecting data much faster than is needed most of the time and faster than can be justified economically generally, storing numbers with apparent precision far beyond the actual accuracy of the measurement equipment. The present patent application appears to be unique in decomposing monitoring data conceptually into (a) important information, (b) unimportant information, and (c) noise:

Observation=Important+Unimportant+noise (1)

It is common in statistics to decompose observations into (i) the true but unknown and unknowable and (ii) noise. We have not previously seen the “true” being further decomposed formally into “Important+Unimportant”. Existing lossy data compression algorithms implicitly decompose the data into “Important” and “Unimportant+noise”, e.g., in digital images with various levels of granularity or in telephone communications where the voice is intelligible except when it is required to clarify a word, to distinguish, e.g., between “pit”, “papa indigo tango” and “bit”, “bravo indigo tango”. Examples such as this show that our modern telephone system sometimes fails to preserve important distinctions between words.

There are various methods for estimating the probability distribution of noise. For example, the standard deviation of normal noise can be estimated by a study of gauge repeatability and reproducibility (Wikipedia, “ANOVA Gauge R&R”). There are many other methods for evaluating the probability distribution of noise from the residuals from of a model. For example, one common tool for evaluating serial dependence is the autocorrelation function (Wikipedia, “Autocorrelation”). If serial dependence is found in residuals, the model has apparently not captured the entire behavior of the plant. In such cases, the standard deviation of the residuals overestimates measurement error. Similarly, normal probability plots (Wikipedia, “Normal probability plot”) are often used to evaluate whether a normal distribution seems plausible and if not to suggest alternatives such as a contaminated normal (Titterington et al. 1985).

If the noise is not normally distributed but follows a distribution from a location-scale family of distributions, the scale factor can still be estimated, e.g., by maximum likelihood or a Bayesian procedure. Each residual is then expressed as an integer multiple of this scale factor. (Autocorrelation, normal probability plots, maximum likelihood and Bayesian estimate are common tools well known among people skilled in the art of data analysis.)

The new data compression methods taught herein begin with state space techniques well known in the statistical literature, e.g., Petris et al. (2009) or Dethlefsen and Lundbye-Christensen (2006). The simplest state space model may be an exponentially weighted moving average (EWMA). For a Kalman formulation of an EWMA, Graves et al. (2002) described how use (a) a gauge repeatability and reproducibility study (Wikipedia, “ANOVA gauge R&R”) to estimate the observation noise level and (b) reliability data to estimate the drift rate (i.e., the probability distribution of if the Kalman migration step). This provides two important advantages over other methods for compressing scientific data, e.g., Fleizach (2006) or Shafaat and Baden (2007): First, it provides statistical theory and a scientific procedure (gauge R&R) for evaluating “how good is good enough?” Second, it incorporates state space representations that could provide a very parsimonious summary that is as good as the physical theory behind the state space representation chosen. The state space representation also includes its own estimate of the uncertainty in its representation of the underlying phenomenon. We have seen nothing else in the literature that explicitly considers the uncertainty in knowledge about the plant.

For example, thin plate splines (Wikipedia, “Thin Plate Spline”) or some other suitable basis set could be used for functional data analysis (Ramsay et al. 2009) of turbulent flow, decomposing the results further into (a) a solution of Navier-Stokes equations, (b) a component that may still represent phenomena different from the hypothesised Navier-Stokes model, and (c) measurement error. This could be applied adaptively as suggested by Shafaat and Baden (2007), but could achieve substantially greater compression through the use of appropriate physical models for the phenomena under study.

Much of the following discussion describes normal observations on a multivariate normal state space with the deterioration or migration including normally distributed random increments. This is chosen for ease of exposition. As anyone skilled in the art of state space modeling knows, the ideas generalize to arbitrary observations and even arbitrary state space with very general evolution and deterioration processes, including observations following discrete distributions whose parameters follow some linear or nonlinear evolution. If the mathematics becomes difficult, they can be approximated in many cases with local linearizations of nonlinear processes. If that is not adequate, one can always move to something like particle filtering (Xue et al. 2009) and/or Markov Chain Monte Carlo (with an increase in the cost of computations).

The key idea is that the last stored model is used as long as it adequately predicts current behavior, with “adequacy” being defined relative to the magnitude of the “unimportant+noise” terms in the decomposition (1): Data inconsistent with predictions trigger data transmission. If the inconsistency seems to be an outlier (or group of outliers) inconsistent with the model, the outlier(s) is (are) transmitted. If the inconsistency suggests the system is following a state space model with the same general structure but different numeric values, that model is updated. In either case, the number of bits or digits transmitted is chosen to drop anything unimportant relative to the “unimportant+noise” portion of (1). Some experimentation might be appropriate to determine optimal rounding, but one would expect that anything smaller than 0.01 times the standard deviation of “important+noise” would contain very little information of practical importance, and in some cases, numbers rounded to the nearest standard deviation of “important+noise” might still retain sufficient information that greater numeric precision may not be worth the cost. This information can then be further compressed using any appropriate data compression system, e.g., transmitting only the differences from the last update when the change is modest relative to the overall magnitude of the numbers. This can result in massive reductions in the cost of data communications and storage, well beyond the current state of the art.

These data compression methods can exploit models of the behavior of the plant being monitored. However, no model is perfect. Accordingly, in addition to transmitting model updates and outliers, a sample of raw data will also be transmitted for subsequent off-line analysis and model improvement efforts (rounded as before to some fraction of the standard deviation of “important+noise”). Moreover, the best lossy compression algorithms could in many cases be improved by applying them to the residuals of the samples from the state space predictions, possibly even “sampling” 100 percent, so all the data are thusly compressed.

These data compression methods can be adaptive with details of the remote data compression algorithm reprogrammed based on earlier data and analyses. Reprogramming can be done either manually or automatically. It can change thresholds for outlier detection and issuing a new report on the condition of the plant. It can also change the basic state space model.

Also, in many applications with remote monitoring equipment, the on-site computer can store raw data that is not transmitted but kept locally for some period of time with older data being routinely overwritten by the new. This is similar to flight recorders on aircraft and can be used for similar forensic engineering purposes.

These cost reductions in data transmission and storage create opportunities for completely new data analysis methods, far beyond anything we have seen in the literature to date.

### BRIEF SUMMARY

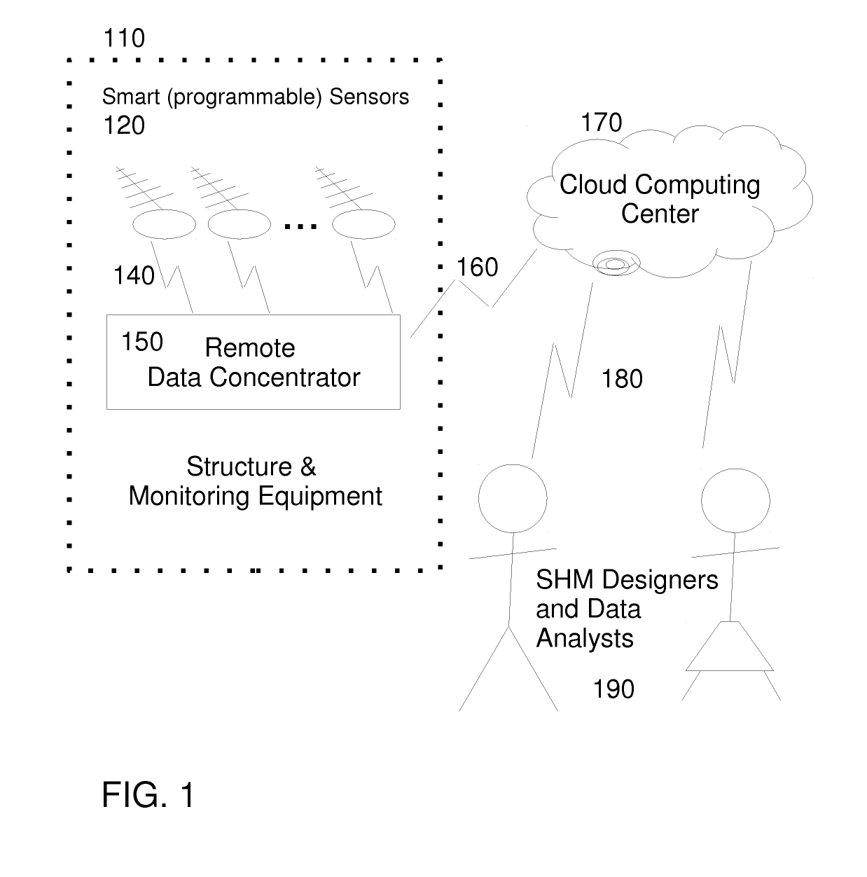

This patent application describes a software system for helping people follow a structured approach to designing monitoring systems. FIG. 1 provides a flow chart for one such structured approach, but of course essentially the same result might be obtained by conceptualizing the steps involved in monitor design in a somewhat different way. Of course, many software systems (whether web based or installed on a privately owned individual computer or an organization's server) exist to help people follow structured approached to various tasks, but none we know for designing monitoring systems. Monitor design is sufficiently esoteric that we have seen very little discussion of it in the literature apart from Box et al. (2000) and Graves et al. (2011). We therefore believe that software for such a purpose is novel, non-obvious and quite useful.

The software system will also include the option of using at appropriate points a new data compression system that summarizes available data as (a) a probability distribution over possible states of a hypothesized plant, combined with (b) a rule describing the evolution (deterministic, stochastic, or a combination) of that probability distribution over time, and (c) a model for observations conditioned on the state of the plant. As each new observation arrives, the previously estimated probability distribution over possible states (the former “posterior” distribution) is updated to the current time, thereby producing a “prior” distribution, which is combined with the latest observation(s) using Bayes' theorem to form the new “posterior”. (This two-step Bayesian sequential updating cycle is further described in Graves 2007 and Graves et al. 2001, 2005.)

The methods taught in this patent application are organized into eight parts: [1] Overview of distributed processing. [2] Monitor design process. [3] Defining “Good” and “Bad”. [4] Overview of the novel state space compression concept. [5] Local data processing at the (typically remote) site of data collection. [6] Data transmission and storage. [7] Data analysis for detecting problems. [8] Data analysis for improving models. There is one Figure for each part.

### BRIEF DESCRIPTION OF THE DRAWINGS

### Figures

FIG. 1. Distributed processing.

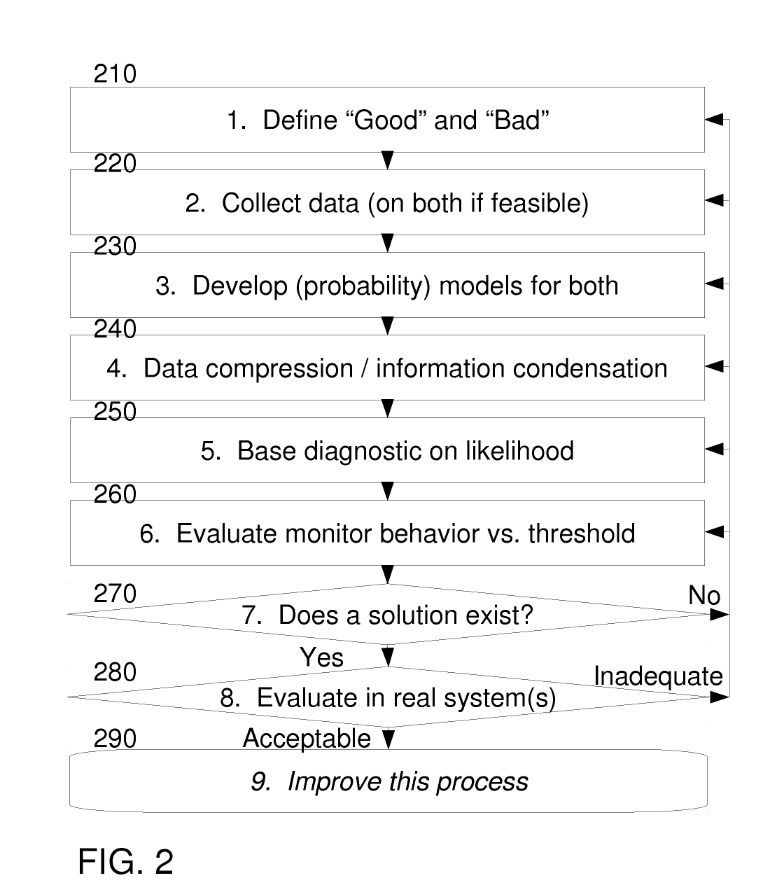

FIG. 2. Monitor design process.

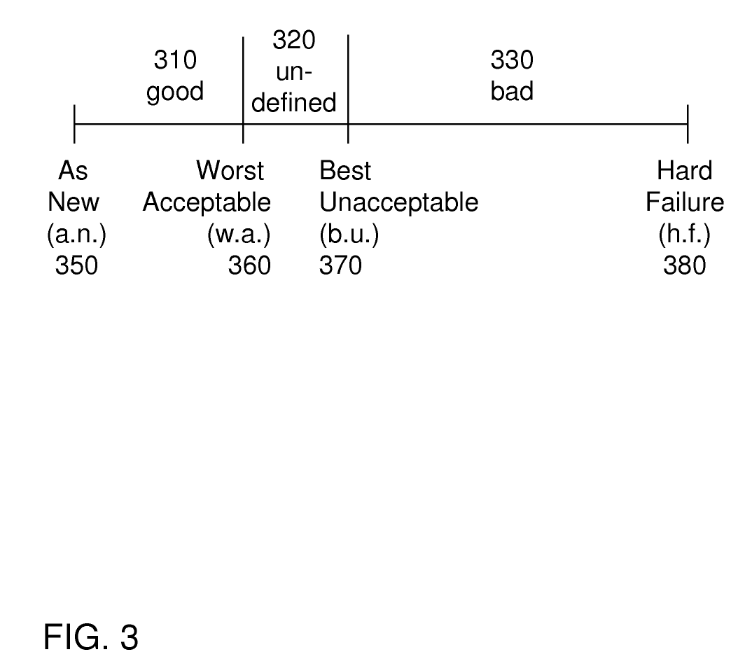

FIG. 3. Defining “Good” and “Bad”.

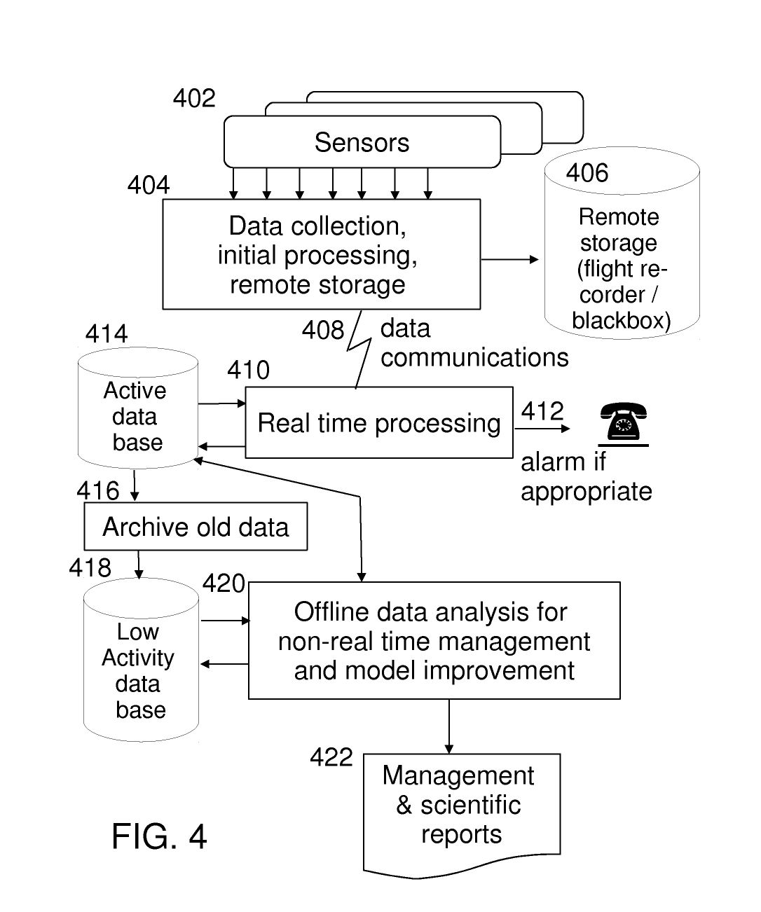

FIG. 4. Overview of data flow management.

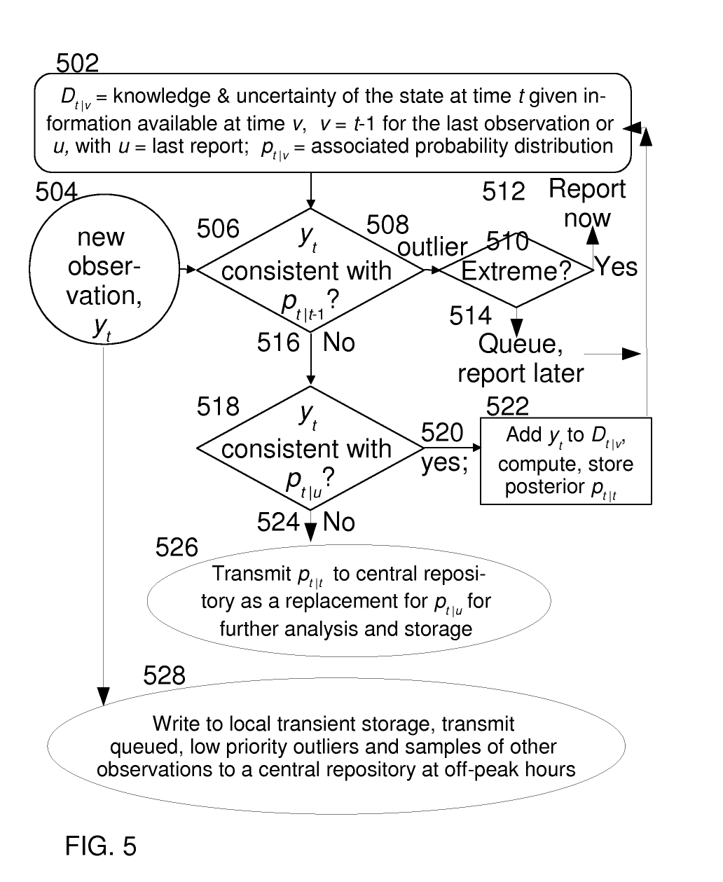

FIG. 5. Local data processing at the (typically remote) data collection site.

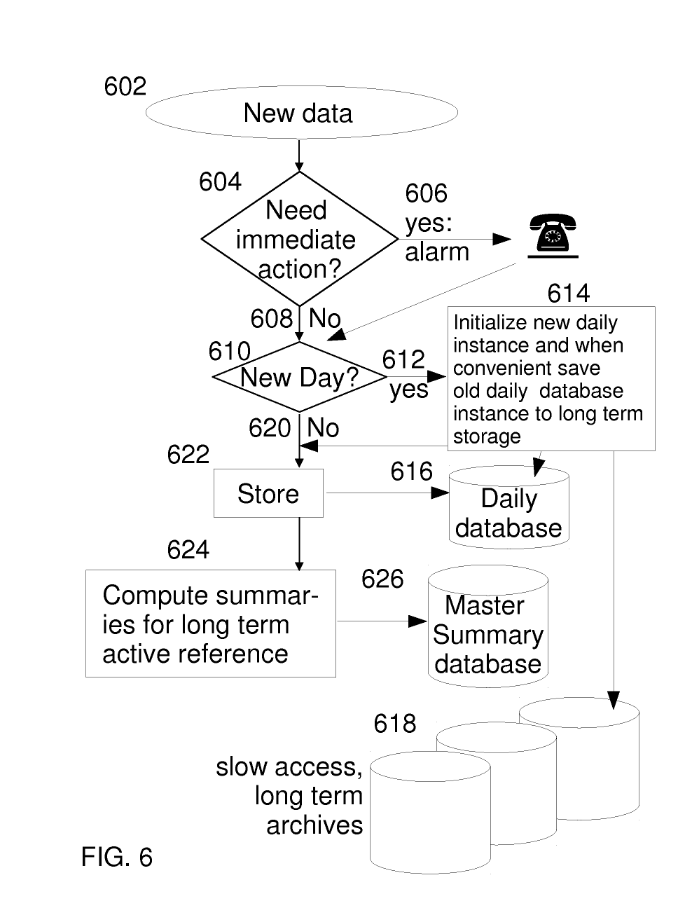

FIG. 6. Enhanced data flow management.

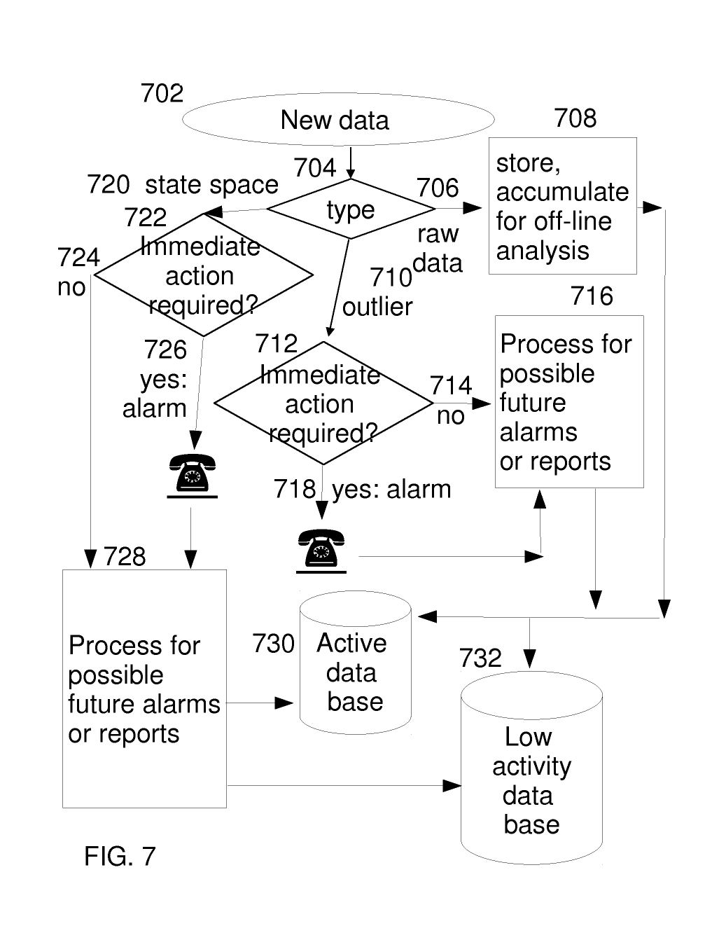

FIG. 7. Data analysis to detect problems.

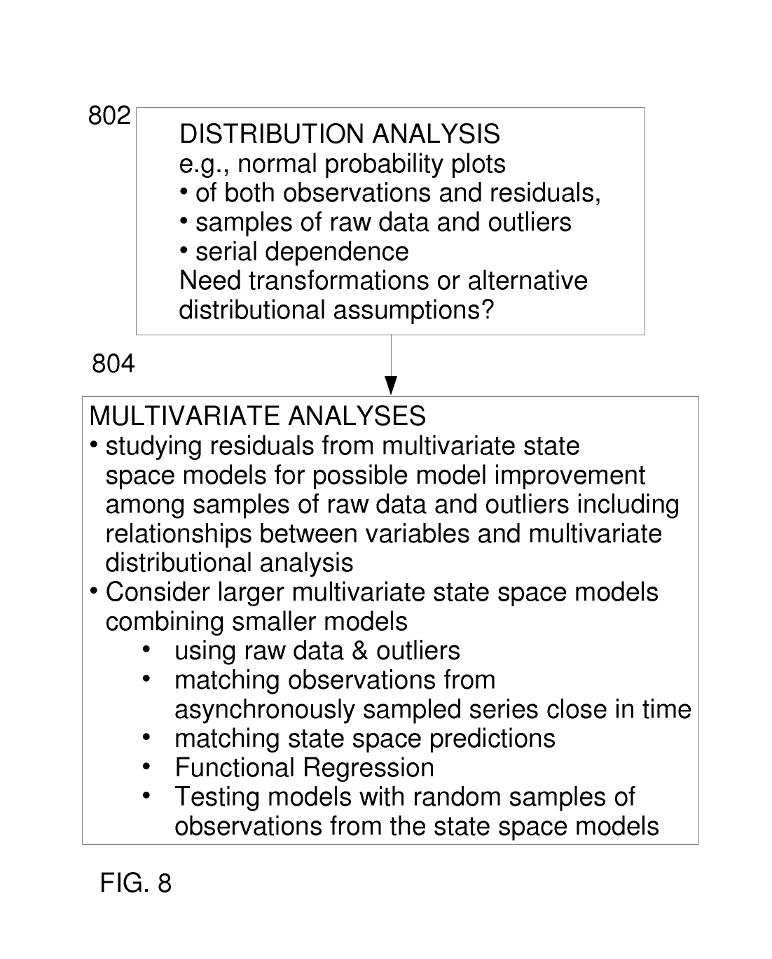

FIG. 8. Data analysis to improve models.

### BRIEF DESCRIPTION OF THE DRAWINGS

Reference Numerals (In this patent application, no numbers are shared between figures, and the first digit provides the Fig. number):
110 Structure and monitoring equipment.
120 Sensors, which may or may not be smart, i.e., programmable.
140 Wired or wireless data communications between the sensors and an optional data concentrator or the cloud computing center.
150 Optional data concentrator possibly collocated with the structure.
160 Wired or wireless data communications between an optional data concentrator or the sensors and the primary data repository, which may be a cloud computing center.
170 Primary data repository, which may or may not be a cloud computing center.
180 Wired or wireless data communications between the primary data repository and end users or computers accessed directly by end users.
190 End users such as designers of structural health monitoring system(s) and/or data analysts.
210 Step to define “Good” and “Bad”.
220 Obtain information on the nature of data to be produced by the monitoring system. This may involve assembling data from testing prototypes or similar equipment and modifying it in various ways if necessary to simulate data from, e.g, a structure yet to be built in both its “Good” state and in possibly a range of “Bad” states.
230 Develop (probability) models for both “Good” and “Bad” systems. In general, there will be a wide range of alternative “Bad” systems that must be detected and a much smaller region of conditions considered “Good”.
240 Determine appropriate statistics to summarize the condition of the system monitored, sometimes called “Information Condensation”. In certain cases, this may be taken a step further to employ various methods of data compression to maximize the amount of information that can be communicated over a given data channel of limited bandwidth and stored on equipment with a certain storage capacity.
250 Base diagnostic on likelihood. Arguably the single most important development in the history of statistical methods is the concept of likelihood. This term refers to using a probability function or probability density function to make inference about unknown parameters defining those probabilities given the data. This is the reverse of the standard use of the phrase probability distribution, which describes the distribution of anticipated future data assuming we know the values of certain parameters.
260 Evaluate monitor behavior vs. threshold: Evaluate the delay to detection and the false alarm or false discovery rate as functions of threshold, and try to find a threshold with a sufficiently quick response to a real malfunction with an acceptably low false alarm or false discovery rate. This often involves computer simulation, though some theoretical results are available for certain simple problems.
270 Does a feasible solution exist? If yes, use it. If no, return to one of the previous steps. For example, returning to 260 could involve more extensive simulations to more accurately characterize the monitor behavior. Returning to 250 could involve a more careful analysis of the likelihood. Going back to 240 could motivate changes retaining more information in the information condensation/data compression step. Box 230 could include plotting data and alternative models more carefully and estimating parameters in more sophisticated models. In box 220, a monitor designer may want to collect more data either over a longer time period or from a wider variety of sources, possibly using more sensors. Alternatively, this may involve thinking more carefully about the likely characteristics of the data from good and malfunctioning systems. Of course, the ultimate way to increase the chances for a feasible solution can be to increase the size of the “Undefined” region in FIG. 3, creating more separation between “Good” and “Bad” in box 210. There are often practical constraints limiting the extent to which this can be done. For example, with on-board diagnostics for emissions controls on automobiles, such practical constraints include legal mandates.
280 Evaluate in a real system. The previous steps involve work with prototypes at best. There are often differences between testing “in vitro” and “in vivo”.
290 Improve this process: Few people, especially working engineers, who design a monitoring system, design only one. After the design process is completed and the monitor is installed (or the project is canceled for whatever reason) the wise professional will invest in a more or less formal review of what went well with the project and what could be improved in the future.
310 “Good” region.
320 “Undefined” region separating “Good” from “Bad”, without which it would be impossible in real applications to obtain a sufficiently quick response to a real malfunction with an acceptable rate of false alarms or false discoveries.
330 “Bad” region.
350 Hypothetical perfect or “as new” condition.
360 Point selected as the “worst acceptable” condition of the plant (i.e., system monitored). In cases where the space of alternative conditions of the plant is considered to be multidimensional, “worst acceptable” would not be a point but rather a manifold separating “Good” from “Undefined”.
370 Point (or manifold) selected as the “best unacceptable” condition of the plant separating “undefined” from “bad”.
402 Sensors measuring quantities of interest.
404 Data collection plus initial data processing and transient storage at or near the activity being monitored.
406 Transient remote storage, similar to a flight recorder or “black box” in an aircraft, designed to survive a catastrophic failure and provide data for subsequent forensic analyses.
408 Data communications using any appropriate methodology whether wired or wireless.
410 Real time processing at a central analysis site.
412 Issue any of a number of possible control signals or alarms of potentially varying severity to different devices, individuals or agencies ranging from emails to responsible individuals requiring action at their convenience to automatically preprogrammed responses, e.g, shutting down a rail line or use of a bridge or calling emergency response teams such as police and/or fire departments.
414 Store the recent data in an “active” database.
416 At regular intervals, e.g., daily, archive old data and modify the active database accordingly.
418 Low activity, cheaper long term data storage.
420 Offline data analysis for non-real time production of management reports and model improvement.
422 Management and scientific reports.
502 Formal summary of information about the state of the plant available at a given time t.
504 Data collection generating new observation yₜ (typically a vector consisting of essentially simultaneous measurements on multiple variables).
506 Decision: Is yₜ consistent with predictions given the past from 502 summarized in p_{t|t-1}?
508 yₜ is an outlier.
510 Is this outlier extreme, requiring immediate action?
512 Extreme outlier: Report now.
514 Outlier but not extreme: Queue to report at an off-peak time for data communications and processing.
516 The new observation seems consistent with p_{t|t-1}.
518 Is the latest observation yₜ consistent with the last state space summary reported to the central repository, p_{t|u}?
520 Yes, yₜ is consistent with p_{t|u},
522 Add yₜ to D_{t|t} updating the posterior p_{t|t}, later used to generate p_{t|t-1} after the next observation arrives and t is incremented
524 yₜ is not consistent with p_{t|u}.
526 Compute p_{t|t} and transmit to the central repository as a replacement for p_{t|u} for further analysis and storage; reset u to t.
528 Write the new observation to local transient storage while managing the transmission of low priority outliers and a sample of other observations during off-peak hours.
602 New data arrives at the central repository.
604 Is this either a sufficiently extreme outlier or a sufficiently inappropriate state space model to require an immediate alarm of one of several degrees of urgency to one or more stakeholders from whom action may be required in response to this latest intelligence, and/or optionally some automatic response such as blocking further traffic on a section of railroad track or public highway or ordering immediate evacuation of some location or shutting down some other process?
606 Yes, this is sufficiently extreme: Issue appropriate alarms and/or other automated action.
608 No: Immediate action is not required.
610 Is this the first observation of a new day or some other epoch such as hour or week requiring the initiation of a new database instance?
612 Yes, this is the first observation of a new instance, e.g., day
614 Proceed with the creating of the required new database instance while triggering a sequence of events archiving the completed instance and eventually removing older data that is no longer needed in active storage.
616 Active database instance for storing the most recent data and compressed state space forms as they arrive.
618 Slow access, long term archives used for generating management reports and scientific/engineering studies to improve the technology.
620 No, this is not a new day or epoch; the database instance for that epoch has already been created.
622 Store the most recent data.
624 On a periodic basis, compute appropriate summaries to retain for long term active reference.
626 Master database containing summaries covering possibly several years and essentially instantly accessible at any time.
702 New data arrives at the central repository.
704 What type of “data” just arrived?
706 Standard “raw data” just arrived.
708 Store the new raw data.
710 An “outlier” just arrived.
712 Is the outlier large enough to require immediate action?
714 No: The latest data is an outlier but not so extreme as to require immediate response based on that observation alone.
716 Process the new outlier to prepare for possible future alarms or reports.
718 Yes: The latest data requires an immediate alarm of some type, whether automatically shutting down some operation or notifying some appropriate stakeholder of the issue.
720 The “new data” is a state space summary of recent observations.
722 Does the change between the previous and the new state space models indicate a need for immediate action?
724 No, this state space summary still indicates the process is operating in an acceptable range.
726 Yes, this state space summary indicates that there is cause for immediate concern. Issue an alarm and/or take other automated action appropriate to the condition.
728 Process the latest state space summary possibly using more complicated multivariate models than used at the remote site to refine the criteria used to evaluate the severity of other data arriving in the future. Store the results as appropriate.
730 Active, quick access storage for state space summaries, optionally including all data received in one current database instance (616 for the current day, week or other selected time chunk) plus a master long term database containing a subset of the current along with subsets or averages of older data 626 (same as 414).
732 Low activity, long term database (same as 618 and 418).
802 Univariate distributional analysis.
804 Multivariate analysis.

### DETAILED DESCRIPTION

### 1. Distributed Processing

With smart sensors 110 and/or a remote data concentrator 150, computations can be performed at various places such the smart sensors, the data concentrator(s) and/or the primary (possibly cloud) data center 170. FIG. 1 shows only one data concentration stage, but of course the idea could be easily extended to multiple data concentration stages by one skilled in the art.

A general rule is to push as much of the computations as feasible as close to the data collection site/physical sensors as feasible. This follows, because data communications often dominate the power requirements at remote locations, especially since the power consumed by many sensors is quite low. The modern microprocessors used in many smart sensors consume relatively little power for computations. This encourages users of smart and wireless sensors to do much of their computations at the sensor node and only transmit terse summaries to a data concentrator at a relatively low frequency. This is especially true with wireless sensors which may be powered using energy harvesting of solar power, local vibrations, or wind, for example, depending on the exact location. In such cases, it may be wise to have the smart sensors store locally data and statistical summaries such as parameter estimates in state space models and only report under special circumstances. If the available power varies with time of day, weather and other conditions, noncritical reports may be stored until adequate power is available to preserve the power required to provide immediate reports if conditions so indicate. This is discussed in more detail with FIGS. 4 and 5.

Eventually (and sooner rather than later with exceptional conditions), data (summaries) ultimately arrive at a primary data repository (such as a cloud computing center), where they are evaluated and stored with possible immediate actions taken as detailed further with FIGS. 6 and 7. The stored data and routine analyses are further made available to SHM system designers and data analysts 190, who may use the data following procedures such as those outlined in FIG. 8.

### 2. Facilitating Shm Design

One embodiment of the present invention is in the form of software to provide a structure to help people follow a sensible process for designing monitors for a variety of processes of interest. A “monitor” in this context is a system for collecting data at potentially informative times, and transmitting either raw data or summary statistics or both at selected times that may be informative, and using said data and/or summary statistics to determine possible interventions to either prevent the system monitored from malfunctioning or to minimize the damage from a malfunction. The structure will provide a step by step process for developing a monitor such as the one outlined in FIG. 2. The particular process discussed in FIG. 2 is discussed further in Graves at al. (2011) and is a slight extension from one taught numerous times since 1999 to automotive engineers involved in developing on-board diagnostics (OBD) to detect potential problems with the emission controls on cars and trucks to be sold in the developed world and in many developing countries. This particular process is however not well known among those skilled in SHM design apart from OBD.

The novelty here is to provide software to make it easy for people new to designing monitors as well as people experienced in the field to design effective monitors with less effort on their part required to remember and do all that is required to design a monitor with the required characteristics.

### 3. Defining “Good” and “Bad”

A lead OBD engineer said that OBD is a problem that looks easy but is in fact hard. This makes career management very difficult for OBD engineers, because their managers have difficulty understanding how OBD design could cost as much as it does. One almost minor portion of the difficulties is the first step in FIG. 2, namely defining “Good” and “Bad”. As suggested in FIG. 3, the range of conditions of virtually any structure occupies a continuum that is often multidimensional (See Box et al. 2000). In such cases, the “worst acceptable” and “best unacceptable” points are selected using engineering judgment, sometimes obtained with statistical imprecision using empirically developed regression equations to transform legal mandated into engineering units.

### 4. Overview of State Space Compression

Box et al. (2000), Graves (2007), and Graves et al. (2011, 2005, 2001), recommend designing monitoring systems by first defining good and bad, then describing how good systems go bad. Cusums have optimality properties for abrupt changes, while more gradually adaptive algorithms such as exponentially weighted moving averages or more general Kalman filters respond better to gradual deterioration. Any of the standard monitoring algorithms can be derived from a two-step Bayesian sequential updating cycle by suitable selection of assumptions for the underlying probability distribution over the state of the plant, the model for how the plant deteriorates and how the observations relate to the condition of the plant. These ideas are the core of FIG. 4 and are foundational for FIGS. 4 through 7. The models used may include a mixture of simpler models, with one model representing normal, appropriate operation of the plant and other models in the mixture representing different failure modes. Common names for such mixture models are Multi-Model Adaptive Estimation (MMAE, e.g., Ormsby 2003) and Ensemble Bayesian Model Averaging (e.g., Fraley et al. 2010). MMAE models may be used at the remote sites or may be restricted to the central site where data from simpler models such as EWMAs are processed with more sophisticated models and used to provide advanced detection and isolation of problems. MMAE and distributed processing are generally well known in the literature. However, it is not well known how to use such models for data compression to support decisions about when to transmit and store details.

Data collection on virtually any process starts with sensors making observations (item 402 in FIG. 4). With physical systems, these could be instruments measuring essentially any physical quantity, digitized by an appropriate analog to digital converter. Some processes involve humans creating written records of what they observe. This can then be converted to machine readable form using a device such as a keyboard or voice recognition software.

In many applications, the data capture uses a computer near the site where the data are collected 404, which may store data and summary statistics in local transient storage 406. Whenever a need for reporting is perceived, data are transmitted 408 to a central location 410 for real time monitoring, which issues alarms 412 as appropriate. As is obvious to anyone skilled in the art, the exact encoding and even the resolution of analog to digital conversion could be adjusted in real time in reaction to other events. For example, the detection of an earthquake in one place could cause the central processing to send commands to remote locations tightening thresholds and scale factors so more data is reported from the remote locations to the central site. These possibilities are not noted in FIG. 4 but would be obvious extensions to anyone skilled in the art.

While we use the word “alarm” here (and elsewhere in this application), the basic ideas could be extended by someone skilled in the art to any real time action, including labeling observations as “exceptions” for future reference, as mentioned above.

A key element of the present invention is deciding when to report data from the remote site 404 to the central site 410 based on the degree to which current behavior of the plant is consistent with predictions based on the most recent previous report. These decisions will typically consider both prediction error bounds and the distance between the estimated state of the plant and some boundary representing a malfunctioning state. These prediction error bounds may be computed using standard statistical theory well known to those skilled in the art. Alternatively, as time passes, if the estimated state of the plant has not changed substantively for a while, that fact can be used to narrow the prediction error bounds. The exact algorithm for narrowing the prediction error bounds may use some exact theory (possibly with Monte Carlo) or a heuristic perceived to provide an acceptable approximation to what might be determined by a more theoretically grounded algorithm.

Real time processing 410 relies on an active database 414 for routine computations. As data ages, the demand for it decreases and some of it is archived 416 to a low activity database 418, where it may still be used for offline analysis 420 to produce management and scientific or engineering reports 422 on how to improve the operations of the system for the future.

Although FIG. 4 shows only two levels of data processing, the extension to multiple levels will be obvious to anyone skilled in the art. For example, a wireless sensor network as described by Wang and Law (2007) could do some data compression locally with each sensor and could report, e.g., Fourier or wavelet transforms or autocorrelations either at regular intervals or using a state space compression as taught in the present patent application to a central data processing unit on the structure being monitored. These data could be further refined on the structure as described with FIGS. 5-7 with appropriate summaries being passed in state space compressed form to a central location where the ultimate data processing, process monitoring, data storage and access for subsequent analyses are done, as outlined in FIG. 1.

Details of local data processing and data compression 404-408 are described in a section below devoted to FIG. 5. Data flow management is discussed at greater length than here with FIG. 6. Monitoring using this compressed format 408-414 is outlined further with FIG. 7. An overview of special techniques for analyzing data in the special compressed format 420, 422 described herein is given with FIG. 8.

### 5. Local Data Processing at the Site of Data Collection

The data compression algorithm taught here rests essentially on Bayesian concepts. Each processing cycle begins with a set D_{t|v} 502 containing all the information available at time v about the state of the plant at time t, t≧v. Processing typically begins with t=v=0 with D_{0|0} being typically though not necessarily the empty set. Associated with D_{t|v} is a probability distribution p_{t|v}.

When each new observation yₜ arrives 504, it is first checked for consistency with the best information previously available summarized in p_{t|t-1} 506. If the probability that it (or a recent string of observations) is unrealistically low, it is labeled an outlier 508. This could involve comparing yₜ with absolute limits. It could also involve comparing the difference between yₜ and predictions per p_{t|t-1} with limits on the absolute prediction error. In addition, the prediction error could be divided by its estimated standard deviation and compared with limits. This evaluation could also be based on processing multiple observations simultaneously. This could be important if the response were categorical rather than continuous.

Each outlier is further processed 510 to determine if is sufficiently extreme to require an immediate report 512 to the central repository 410 of FIG. 4 for immediate processing. Others are queued 514 to be reported later either when a subsequent outlier suggests they should should be reported now or during an off-peak time for either data communications or central processing.

If yₜ is consistent with p_{t|t-1} 516, we then want to know if it (possibly combined with observations since the last update time u) is (are) consistent with the last reported state space model p_{t|u} 518. This evaluation may use standard statistical theory for determining prediction limits possibly shrunk to account for the information contained in the fact that another update has not been made since time u, as discussed with 404 in FIG. 4 above. Similarly, these prediction limits may be expanded rather than shrunk in step 508 or 510 should outlier(s) be detected. The exact algorithm for this may be complete ad hoc, based on something deemed plausible, or may employ varying degrees of statistical sophistication, possibly justified in part by data analyis, e.g., as outlined with FIG. 8 below. The difference between yₜ and prediction per p_{t|u} can be compared with both absolute and relative limits.

If the latest observation is consistent the last reported state space model p_{t|u} 520, it is added to the database and used to compute the posterior distribution p_{t|t} 522. If yₜ is not consistent with p_{t|u} 524, the latest posterior p_{t|t} is computed and transmitted to a central repository as an update for p_{t|t} 526, where it can be used for both real time monitoring and off line data analysis to improve management of the plant, possibly via improved scientific/engineering understanding of its behavior.

The processing of FIG. 5 can be easily generalized by anyone skilled in the art to include more comparisons and decisions than just those listed. For example, if the posterior mean is outside prespecified limits while the previously reported posterior mean is inside, this can trigger a report.

In addition to the immediate processing 506-526, each observation is written to local transient storage. From there asynchronously, all outliers and samples of other observations are transmitted 528 to the central repository for further processing. These samples may be selected via simple random sampling or in bursts with randomly selected starting points or systematically, initiated under certain conditions. For example, Rutz and Rens (2008) sampled data every 0.1 sec. but only when the wind was of certain intensities and from specific directions.

This transient storage can then be accessed manually, typically after a failure of the plant, as it may provide more detail of the recent history. With a failure of this local monitoring system (e.g., accompanying a failure of the plant monitored), this transient storage may help people understand the failure.

For the present applications, we could apply any reasonable method for lossy data compression to the numbers in the state space representation and to the random samples and outliers identified for transmission to the primary data repository (170 in FIG. 1) provided the method chosen appropriately considers the trichotomy between “important”, “unimportant”, and “noise” described with (1) above. Several such methods involve computing the difference between a number and some reference point, dividing the result by a scale factor and rounding to the nearest integer. Methods differ in the choice of reference (e.g., the last observation or a number close to the long term average) and the scale factor. If the scale factor is modest, e.g., 0.1 or 0.3 times the standard deviation of the numbers being rounded, the distribution of discarded fractional part will be fairly close to uniform with high probability. (With normally distributed numbers, for example, the farther the number is from the mean, the less uniform will be the distribution of the discarded fractional part. However, large deviations only rarely occur, so the nonuniform nature of the distributions of those discarded fractional parts is less important.)

Design of a reasonable state space compression system must carefully consider the three components of expression (1) above along with the migration/deterioration portion of the state space model. If typical changes in the state are small relative to the typical magnitude of the numbers [e.g., the “important” part of (1)], a standard tool of data compression is to transmit and store the change from the previous update, as it would have fewer bits or digits than the whole number. To protect against problems from transmission errors, it may be wise in such cases to schedule transmission of the full numbers after dropping part of the number that clearly represents “noise” in (1) and possibly also part or all of the “unimportant”. In any event, it will only rarely be necessary to carry numbers more accurate than some fraction (such as 0.1 or 0.3) of the maximum of the noise standard deviation and a comparable measure of what variations would be considered unimportant. In many cases, this can be implemented by appropriate centering and scaling, i.e., subtracting a center from each number and dividing by a scale factor, then rounding the result to obtain an integer for transmission and/or storage.

This gives us several things to consider in tailoring a state space compression algorithm to a particular application: (a) Modifying the state space model used, e.g., replacing an exponentially weighted moving average with a model that considers temperature or time of day in making predictions. When appropriate, modifications like this can reduce the noise, making predictions more accurate and possibly reducing the frequency with which reports are required to achieve a given level of accuracy in predicting future observations. (b) Adjusting the sampling frequency, i.e., thresholds for when an update is required or an observation is declared an outlier or selecting a sampling frequency for raw data. (c) Adjusting the number of bits or digits to carry in the numbers, as just discussed. In many cases, the system can be optimized by standard methods of empirical optimization (e.g., Box and Draper 2007), especially if the remote system of FIG. 5 can be reprogrammed while in use, at least by modifying specifications of limits for identifying outliers and reporting conditions plus center and scale for data transmission and storage.

### 6. Enhanced Data Flow Management

By enhanced data flow management, we mean managing increasing volumes of data, proactively designing and managing a database management system with the flexibility to quickly adjust to rapid changes in the volumes of data and the number of sources. A small part of this is outlined in FIG. 6, where arrival of new data 604 triggers an evaluation of whether an alarm should be issued 606. Whether an alarm is required or not 608, the new data are then checked to determine if this represents a new epoch, e.g., a new day 610. An epoch can have different sizes depending on the application and the volume of data arriving: Higher volume data may require a shorter epoch. The length of the epoch must be chosen to facilitate management of the data so that older data can be easily moved to lower cost, longer response time storage.

If the new data are from a new epoch, the decision 610 then flows 612 to a step 614 that creates a new database instance for the new epoch 616 while initiating a process to move some older data as convenient to slower access, long term storage 618 to create space on the faster access storage for more data. Whether the new data are from a new epoch nor not 620, it is stored 622 in the active database for that epoch 616. Then at appropriate intervals, data may be further compressed, summarized or subsampled for long term active reference 624 in a master database 626. For convenience in this discussion, we may refer to a “Daily database” as a shorthand for “Active database for the current epoch”, even if the chosen epoch is not a single day, and the actual system may involve more that two levels, e.g. with a fast epoch of each hour storing summaries in a database with a slow epoch of a week storing fewer summaries in the final master summary database that is presumably sufficiently sparse to not require further data concentration.

With appropriate data compression at a remote site, the volume of data at a central site may be low enough that the “Daily database” and “Master summary database” may be combined.

With large numbers of sites, a “Daily database” instance may be constructed for each combination of epoch and remote site (or data source). Meanwhile, the “Master summary database” may be combined for a group of sites sharing common characteristics in addition to or in lieu of having a “Master summary database” for each site. For example, to manage an inventory, e.g., of bridges, it may be desired to construct a combined “Master summary database” that includes data so it is easy to combine data from sources (bridges) of similar design, age, material, length, or any other characteristic of interest.

### 7. Data Analysis for Fault Detection

The two-step Bayesian sequential updating cycle described in Graves (2007) and Graves et al. (2005, 2001) needs to be modified for multistage processing of data collected and reported as taught in the present patent application. As noted with FIG. 7, new data 702 are transmitted to the central site in three different forms or “types” 704: (a) samples (e.g., random or systematic) of raw data 706, (b) outliers 710, and (c) state space model summaries 720. Each must be interpreted differently.

Raw data 706 must be stored 708 for future reference in studies of whether and how models can and should be improved. Outliers 710 must first be evaluated to determine if immediate action is required 712. If the observation is a statistical outlier without apparent practical importance 714, the observation should still be processed and stored for future reference as appropriate 716. This processing may be different depending on whether the state space models estimated at the remote site 720 includes explicit consideration of outliers, e.g., by assuming that outliers follow a contaminated normal distribution. If the outlier is sufficiently extreme to require immediate action 718, an appropriate alarm is issued to any of several possible stakeholders depending on the exact nature of the outlier. In either case, the outliers would then be further processed to prepare to react more appropriately to other outliers received in the future, possibly increasing the probability of taking other action upon the arrival of other observations in the future.

The monitoring system must include procedures (not shown in FIG. 7) so the alarms can be modified by people responsible for managing the plant. This is important to maximize the chances that people will use the system appropriately. With too many alarms, people will simply ignore them, thereby contributing to “Normal Accidents” (Wikipedia “System Accident”). If the system is too hard to evaluate and adjust, people will sometimes disable the alarms if they can or ignore them if they cannot.

Processing of state space changes 720 will be somewhat different from traditional theory, because they will only be reported if the last reported state space model estimate is inconsistent with the currently stored model. This fact means that the absence of a report itself provides information that the changes since the last reported state space estimate are not great, e.g., in step 728 and the result that is stored 730. Conversely, reported outliers 710 may provide evidence questioning the need to narrow such limits, e.g., in step 716. These observations suggest opportunities to modify the standard deterioration step in the Bayesian two-step sequential updating cycle. Careful statistical analysis might provide a precise method for modeling deterioration to incorporate the information contained in the absence of an update. However, sensible results will likely be obtained by simpler ad hoc adjustments merely limiting the growth in the uncertainty of the probability model portion of the state space estimate.

If immediate action seems to be required, any of a number of previously programmed alternative actions will be taken 726. Whether or not 724 immediate action is required, the new state space model may be further processed for possible future alarms or reports. A first step in this will be to store the newly reported state space model in the active database. Further processing may use the new report to update a variety of potentially more sophisticated models developed since the design of the remote monitoring system. This might be used in conditions where the remote monitoring system may be difficult to update or of limited computational capacity while the central processing might be more easily changed and enhanced to reflect new knowledge acquired in management, scientific or engineering studies as discussed with FIG. 8. In any event, this processing will also include computation of efficient summaries to be kept in the active database and backing up older data to a low activity database 732 as described with FIGS. 4 and 6.

### 8. Data Analysis for Model Improvement

State space data compression opens many possibilities for completely new methods of statistical analysis to exploit its unique character. We consider distribution analysis 802 in FIG. 8 separate from multivariate analysis 804.

One of the most powerful methods for univariate distribution analysis is a QQ plot, especially a normal probability plot. However, the raw data available will typically be a mixture of 100 percent of observations beyond certain limits (outliers) and some small percentage of samples from the central region of the distribution. QQ plotting algorithms will need to be modified to consider the limits and the sampling frequencies in different ranges.

One of the primary reasons for making QQ plots, especially normal probability plots, is to help understand any outlier mechanism. Normal data plot close to a straight line in a normal probability plot. Data with outliers that come from a complete different distribution typically present the appearance of two or more straight line segments in a normal plot. For example, if the outliers come from a normal distribution with a higher standard deviation, the data from the distribution with the smaller standard deviation will appear straight with one slope while much of the data from the distribution with a higher standard deviation may appear at both ends of the central distribution with a common but different slope proportional to the higher standard deviation. From examining the plot, one can get rough estimates of the means and standard deviations of the two components of the mixture as well as the percent of observations from each distribution (Titterington et al. 1985). On other occasions, a normal probability plot may look like a relatively smooth curve. This could indicate a need for a transformation or possibly a skewed or long-tailed distribution. However, with raw data sampled as described here, the sampling method must be considered appropriately in construction of a QQ plot, as without that the image in the plot could be very misleading.

Similarly methods for evaluating serial dependence will need to consider the sampling methodologies used with the raw data. Sampling bursts of data will support estimation of short term serial dependence. Observations collected farther apart in time will need to consider the time difference between observations.

Similar plots might be made of the mean vectors in the state space representation and of their first differences. However, again the reporting process must be appropriately considered in the construction of distributional analyses.

Good statistical practice typically starts, as just outlined, with univariate distributional analyses. This is because multivariate analyses imply certain assumptions for the univariate components, and violations of these assumptions are so common that much time can be wasted on inappropriate multivariate analyses if the basic univariate distributional assumptions are not checked first.

The new state space data compression methods taught in this patent application provide opportunities for at least three very different kinds of multivariate analyses. First, if the state space model used at the remote site includes multivariate observations, then the multivariate residuals should be considered for consistency with the multivariate observation component of the state space model. Multivariate normal residuals from a state space model can be examined together as a Hotelling's T-square. That is either a scaled chi-square or an F distribution, and QQ plots appropriate to those distributions can be profitably examined (adjusting as before for the sampling methodology). Other plots of observations and residuals can be used to look for relationships different from those assumed in the model.

Beyond this, in many cases, the data compression at the remote site will involve relatively simple models, e.g., exponentially weighted moving averages (EWMAs), while more complicated models can be developed later to exploit a better understanding of the relationships between variables. For example, data from a bridge might include temperature and various measures of the motion of the bridge due to thermal effects. The installation at the remote site might provide updates on all variables simultaneously or apply a state space compression algorithm to each variable separately. Analysis of data from simultaneous updates will be easier, but separate compression of each variable might be more efficient in the cost of data communications and storage, depending on the reporting frequencies of the different models.

With asynchronous reporting, various methods can be used to look for relationships between different variables. For example, pseudo-observations can be constructed at selected points in time for variables of interest using the state space models. An advantage of this is that each pseudo-observation comes with an estimate of standard error that could be used in the analysis. However, these pseudo-observations will rarely be statistically independent. This fact will invalidate standard statistical tests that might otherwise be performed. New models may need to be tested using the samples of raw data reported to the central database.

Alternatively, techniques for functional regression and correlation might be used (Ramsay et al. 2009). This might be particularly valuable with monitoring thermal effects on a structure, where temperature is measured at only one point on the bridge and uniform heating cannot be assumed.

### CONCLUSION

### Ramifications and Scope

This patent application teaches those skilled in the arts of data compression and statistical analysis how to dramatically reduce the volume of data transmitted and stored to characterize the evolution of a system of interest, called a “plant” for consistency with the control theory literature. It does this by summarizing virtually any kind of data into an appropriate state space model and transmitting and storing the state space model only when the previously stored model does not adequately predict recent observation(s) and transmitting only enough bits of digits required to retain the important information. This document also provides an overview of special data analysis procedures required to extract information from this new data compression format. This patent application also teaches basic concepts of data flow management as applied to data compressed using the state space summarization methods taught herein. These techniques can be applied with a simple monitoring system involving only one computer or a distributed system involving multiple levels of data compression and analysis following this general outline before the data arrives at a central data center for global data analysis and storage. These methods become increasingly important with increases in the numbers of sensor nodes, sampling frequency, plants being monitored and with the general complexity of the infrastructure.

### REFERENCES CITED

### U.S. Patent Documents

| | | |
|---|---|---|
| 6,351,218 | February 2002 | Smith. |
| 6,646,559 | November 2004 | Smith. |
| 6,947,842 | September 2005 | Smith et al.. |

### REFERENCES

Benjamini, Yoav, and Hochberg, Yosef (1995). “Controlling the false discovery rate: a practical and powerful approach to multiple testing” Journal of the Royal Statistical Society, Series B (Methodological) 57 (1): 289-300.
Box, George E. P., and Draper, Norman R. (2007) Response Surfaces, Mixtures, and Ridge Analyses (Wiley)
Box, G., Graves, S., Bisgaard, S., Van Gilder J., Marko K., James J., Seifer M., Poublon M., and Fodale, F. (2000) “Detecting Malfunctions in Dynamic Systems”, Proceedings of the 2000 SAE World Congress & Exposition (SAE Technical Paper Series number 2000-01-0363).
Cheng, Jimming, and Metzenmacher, Michael (2005) “The Markov Expert for Finding Episodes in Time Series”, Proceedings of the 2005 Data Compression Conference (www.eecs.harvard.edu/˜michaelm/postscripts/jsubmit.pdf, accessed 2010.07.01).
Choi, Myoungkeun, and Sweetman, Bart (2009) “Efficient Calculation of Statistical Moments for Structural Health Monitoring”, Structural Health Monitoring, 9: 13-24.
Dethlefsen, C., and Lundbye-Christensen, S. (2006) “Formulating state space models in R with focus on longitudinal regression models”, Journal of Statistical Software, 16(1) (www.jstatsoft.org/v16/i01/paper, accessed 2010.12.04)
Fink, Eugene, and Gandhi, Harith Suman (2007) “Important Extrema of Time Series”, Computer Science, Carnegie Mellon U. (www.cs.cmu.edu/˜eugene/research/full/important-extrema.pdf, accessed 2010.07.01).
Fleizach, Chris (2006) “Scientific Data Compression Through Wavelet Transformation” (unpublished, “http://www.fightliteracy.com/wavecomp/docs/project_writeup.pdf”, accessed 2010 Dec. 31).
Fraley, Chris, Raftery, Adrian E., Sloughter, J. McLean, Gneiting, Tilmann, Yuen, Bobby, and Polokowski, Michael (2010). ensembleBMA: Probabilistic Forecasting using Ensembles and Bayesian Model Averaging. R package version 4.5 (http://CRAN.R-project.org/package=ensembleBMA, accessed 2010 Dec. 13)
Graves, Spencer (2007) “Bayes' Rule of Information and Monitoring in Manufacturing Integrated Circuits”, Blanca Colosimo and Enrique del Castillo (2007) Bayesian Process Monitoring, Control and Optimization (Chapman & Hall)
   (2011) “Off-Line Data Analysis and Real-Time Fault Detection and Isolation with Distributed Processing and State Space Compression”, Proceedings of the 2011 Joint Statistical Meetings.
Graves, Spencer, Bisgaard, Søren, Kulachi, Murat (2002) “Designing Bayesian EWMA Monitors Using Gage R & R and Reliability Data” (www.prodsyse.com/Bayesian %20EWMA.pdf, accessed 2010 Dec. 14)
   (2005) “A Bayes-Adjusted Cumulative Sum” (www.prodsyse.com/Bayes-Adj %20Cusum2.pdf, accessed 2010 Dec. 4)
Graves, Spencer, Bisgaard, Søren, Kulachi, Murat, Van Gilder, John, Ting, Tom, Marko, Ken, James, John, Zatorski, Hal, and Wu, Cuiping (2001) Foundations of Monitoring Dynamic Systems (www.prodsyse.com; accessed 2009 Aug. 2).
Graves, Spencer, Rens, Kevin, and Rutz, Fred (2011) “A 9-Step Process for Developing a Structural Health Monitoring System”, in Fu-Kuo Chang, Structural Health Monitoring 2011 (DEStech Publications, Lancaster, Pa.)
Huang, Junzhou, Zhang, Shaoting, and Metaxas, Dimitris (2011) “Efficient MR Image Reconstruction for Compressed MR Imaging”, Medical Image Analysis, 15(5)670-679.
Izumi, Tetsuya, and Iiguni, Youji (2006) “Data Compression of Nonlinear Time Series using a Hybrid Linear/Nonlineaer Predictor”, Signal Processing, 86: 2439-2446.
LabJack (2010) “U6” (“http://labjack.com/u6”, accessed 2011 Jan. 2).
Lazaridis, losif, and Mehrotra, Sharad (2003) “Capturing Sensor-Generated Time Series with Quality Guarantees”, Proceedings of the 19th International Conference on Data Engineering, 429-440).
Li, Lei (2010) “Fast Algorithms for Time Series Mining”, ICDE Workshops 2010, 341-344.
Olfati-Saber, Reza (2007) “Distributed Kalman Filtering for Sensor Networks,” Proc. of the 46th IEEE Conference on Decision and Control (http://engineering.dartmouth. edu/˜Reza_Olfati_Saber/papers/cdc07_dkf.pdf, accessed 2010 Jun. 4)
Ormsby, Charles D. (2003) Generalized Residual Multiple Model Adaptive Estimation of Parameters and States (US Air Force Institute of Technology report AFIT/DS/ENG/03-08; “https://research.maxwell.af.mil/papers/ay2004/afit/AFIT-DS-ENG-03-08.pdf” accessed 2010 Dec. 2013)
Petris, Giovanni, Petrone, Sonia, and Campagnoli, Patrizia (2009) Dynamic Linear Models with R (Springer).
Ramsay, James, Hooker, Giles, and Graves, Spencer (2009) Functional Data Analysis with R and Matlab (Springer).
Reddy, K. Ashoka, George, Boby, and Kumar, V. Jagadeesh (2009) “Use of Fourier Series Analysis for Motion Artifact Reduction and Data Compression of Photoplethysmographic Signals”, IEEE Transactions on Instrumentation and Measurement, 58(5): 1706-1711.
Rutz, Frederick R., and Rens, Kevin L. (2008) “Wind Pressure and Strain Measurements on Bridges. I: Instrumentation/Data Collection System”, Journal of Performance of Constructed Facilities, 22(1) 2-11.
Ryabko, Boris (2008) “Applications of Kolmogorov Complexity and Universal Codes to Nonparametric Estimation of Characteristics of Time Series”, Fundamenta Informaticae, 83: 177-196.
   (2009) “Compression-Based Methods for Nonparametric Prediction and Estimation of some Characteristics of Time Series”, IEEE Transactions on Information Theory, 55(9): 4309-4315.
Shafaat, Tallat M., and Baden, Scott B. (2007) “A Method of Adaptive Coarsening for Compressing Scientific Datasets”, PARA'06 Proceedings of the 8th international conference on Applied parallel computing: state of the art in scientific computing (ACM Digital Library).
Shewhart, Walter A. (1931) Economic Control of Quality of Manufactured Product (1980 reprint: American Society for Quality Control).
Soloman, David, and Motta, Giovanni (2010) Handbook of Data Compression, 5th ed. (Springer)
Sridhar, S., Ravisankar, K., Sreeshylam, P., Parivallal, S., Kesavan, K., and Murthy, S. G. N. (2009) “Development of a Real-time Remote Structural Monitoring Scheme for Civil Infrastructural Systems, Structural Health Monitoring, 8(6): 509-521.
Titterington, D. M., Smith, A. F. M., and Makov, U. E. (1985) Statistical Analysis of Finite Mixture Distributions (Wiley).
Titchener, M. R. (2008) “Towards Real-Time Measurement of Information in a Scientific Setting”, 6th International Symposium on Communication Systems, Networks and Digital Signal Processing, 316-320

Wang, Yang, and Law, Kincho H. (2007) Wireless Sensing and Decentralized Control for Civil Structures: Theory and Implementation, Report No. 167, Blume Earthquake Engineering Center, Stanford U. (https://blume.stanford.edu/tech_reports, accessed 2010 Dec. 4)
Wenzel, Helmut (2009) Health Monitoring of Bridges (Wiley)
Wikipedia “ANOVA Gauge R&R” (http://en.wikipedia.org/wiki/ANOVA_Gauge_R&R, accessed 2010 Nov. 21).
   “Autocorrelation” (http://en.wikipedia.org/wiki/Autocorrelation, accessed 2010 Nov. 23)
   “Data Compression” (http://en.wikipedia.org/wiki/Data_compression, accessed 2010 Jul. 1).
   “Decision Theory” (http://en.wikipedia.org/wiki/Decision_theory, accessed 2010 Jun. 28).
   “Lossy Compression” (http://en.wikipedia.org/wiki/Lossy_data_compression, accessed 2010 Jul. 1).
   “Normal probability plot (http://en.wikipedia.org/wiki/Normal_probability_plot, accessed 2010 Nov. 23).
   “Statistical Hypothesis Testing” (http://en.wikipedia.org/wiki/Statistical_hypothesis_testing, accessed 2010 Jun. 29)
   “Statistical Process Control” (http://en.wikipedia.org/wiki/Statistical_process_control, accessed 2010 Jun. 29).
   “System Accident” (http://en.wikipedia.org/wiki/System_accident, accessed 2010 Dec. 4)
   “Thin Plate Spline” (http://en.wikipedia.org/wiki/Thin_plate_spline, accessed 2011 Dec. 22)
Xue, Songtao, Tang, Hesheng, and Xie, Qiang (2009) “Structural Damage Detection Using Auxiliary Particle Filtering Method”, Structural Health Monitoring, 8: 101-112.

We claim the following:

1. A data compression machine comprised of an algorithm or software that replaces measurements with a state space representation.

2. The data compression machine of claim 1 wherein reports are made to a data concentrator or a central database only when the last reported state is not adequate to permit reconstruction of the existing data to acceptable precision.

3. The data compression machine of claim 1 wherein sampling and reporting are adjusted to preserve the electrical power required to detect and report quickly major malfunctions, while lower priority data are stored locally waiting for the arrival of sufficient power to support more complete reporting.

4. The data compression machine of claim 1 wherein some quantity of recently sampled data is stored locally without being transmitted to a central database, said local storage to support forensic engineering evaluations in case of a failure of a structure, similar to flight recorders on aircraft.

5. The data compression machine of claim 1 wherein the said state space representation may be altered depending on the goodness of fit to the data, including the option of reporting a subsample of outliers.

6. The data compression machine of claim 1 wherein the said state space representation includes models of (a) its state or condition, (b) the evolution over time of the said state or condition, plus (c) a probability model describing the probability distribution of the data collected as a function of the said state or condition.

7. The data compression machine of claim 6 wherein the model of evolution includes additive deterministic and random components describing a random walk with possibly a deterministic component that may optionally depend on other inputs.

8. The data compression machine of claim 6 wherein the probability distribution of the data has a mean that is a linear function of the state or condition.

9. A machine to facilitate learning and practicing an effective and efficient process for designing monitors for human and physical processes comprised of an algorithm or software with a graphical user interface providing a system to (a) remind users of the recommended steps and (b) record various previous inputs and tailor further use of the system based on said previous inputs.

10. The machine of claim 9 wherein the said process is the 9-step process of FIG. 1 and the companion discussion.

11. The machine of claim 9 wherein the software is available via either a web portal or user software installed on a computer owned by the user or a server accessed by the user.
